(19) United States
(12) Patent Application Publication
(10) Pub. No.: US 2021/0057842 A1
(43) Pub. Date: Feb. 25, 2021

(54) TELESCOPING BACKSHELL

(71) Applicant: Raytheon Company, Waltham, MA (US)

(72) Inventors: Brian L. Taylor, McKinney, TX (US); Steven Sprinkle, McKinney, TX (US)

(73) Assignee: Raytheon Company, Waltham, MA (US)

(21) Appl. No.: 16/546,398

(22) Filed: Aug. 21, 2019

(51) Int. Cl. H01R 13/502; H01R 13/52; H01R 13/6581

(52) U.S. Cl. CPC H01R 13/502; H01Q 3/26; H01R 13/6581; H01R 13/5202

(57) ABSTRACT

A backshell includes a substrate having a lower surface and an upper surface and a lower connector having a first groove defined therein. A first gasket is disposed in the first groove and the lower connector is positioned on the lower surface to capture the first gasket in the first groove. The backshell assembly includes a second groove defined in a first connector and a second gasket is disposed in the second groove. The first connector is positioned to capture the second gasket in the second groove. The backshell assembly includes a third groove and a third gasket disposed in the third groove. A second connector is disposed about the first connector to enclose the third gasket in the third groove such that the second connector is capable of moving along the Z-axis while maintaining the third gasket in the third.

### FIELD OF THE INVENTION

The disclosure relates to a new architecture for a connector used in isolating components from electromagnetic interference (EMI). More particularly, the disclosure relates to a backshell assembly for reducing EMI degradation on antenna performance.

### BACKGROUND OF THE INVENTION

Getting power to line-replaceable units (LRUs) has always been a challenge as issues of inductance, isolation, cost, and weight are involved. This challenge is amplified for phased array antennas as usually the power supply needs to be close to the load and array electronics. The physical lengths of interconnects coupled with the shear amount of current that may be required, create a noisy environment. This effect sets up the potential for a receiver/exciter (REX) and a digital receiver/exciter (DREX) to pick up these signals, thus drastically degrading antenna performance.

Traditionally, a DC power interconnect consists of cabling or busbars from a rear cover to a power supply. Inductance in these setups is addressed by laminating the positive to the negative in a busbar and/or twisted pairs in a traditional cable. Isolation is typically handled by physical barriers in the system such as a ferromagnetic shield structure, and/or in the case of flex interconnect adding layers on top and bottom for ground.

However, there is a need for a device to address various issues in phased array antennas when power supplies are integrated with the phased array.

### BRIEF SUMMARY OF THE INVENTION

According to various embodiments, a backshell assembly is provided. The backshell assembly includes a substrate having a lower surface and an upper surface, and a lower connector. The backshell assembly can include a first gasket disposed in the lower connector, wherein the lower connector can be positioned on the substrate lower surface to capture the first gasket between the lower connector and the substrate lower surface. Further, the backshell assembly can have a first connector with an outer surface and a space defined therein, having a first end and a second end, wherein a virtual Z-axis can be defined from the first end to the second end.

In addition, the backshell assembly can have a second gasket disposed around a circumference of the first connector, wherein the first connector can be positioned on the substrate upper surface to capture the second gasket between the first connector and the substrate upper surface.

Further, the backshell assembly can have a third gasket disposed in the outer surface of the first connector and adjacent to the second end of the first connector.

Further, the backshell assembly can have a second connector having a first portion with a second length along the Z-axis, wherein the first portion of the second connector can be disposed about the second end of the first connector to enclose the third gasket between the first connector and the second connector. The second length can be at least as long as a diameter of the third groove such that the second connector is capable of moving along the Z-axis to maintain the third gasket between the first connector and the second connector. Each of the first, second and third gaskets can comprise an EMI shielding material.

### BRIEF DESCRIPTION OF THE DRAWINGS

Various aspects of at least one embodiment of the present disclosure are discussed below with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The figures are provided for the purposes of illustration and explanation and are not intended as a definition of the limits of the invention.

FIG. 1 illustrates a backshell assembly according to certain embodiments;

FIG. 2 illustrates a backshell assembly of FIG. 1 with accessory connector D38999 removed;

FIGS. 3A-3C illustrates various views of accessory connector D38999; and

FIG. 4 illustrates an exemplary EMI shielding gasket.

### DETAILED DESCRIPTION

In the following detailed description, numerous specific details are set forth in order to provide a thorough understanding of the embodiments of the present disclosure. It will be understood by those of ordinary skill in the art that these embodiments may be practiced without some of these specific details. In other instances, well-known methods, procedures, components and structures may not have been described in detail so as not to obscure the described embodiments.

Prior to explaining at least one embodiment in detail, it is to be understood that these are not limited in their application to the details of construction and the arrangement of the components set forth in the following description or illustrated in the drawings. Also, it is to be understood that the phraseology and terminology employed herein are for the purpose of description only and should not be regarded as limiting.

The present disclosure solves various issues in Phased Array Antennas when power supplies are integrated with the Phased Array. For example, the device reduces or eliminates system noise by implementation of a Faraday cage around input power interconnects and reduces inductance in power interconnects. Further, aspects of the present disclosure reduces system weight and system cost.

More specifically, the present disclosure provides a novel device to maintain a Faraday cage in both fixed and dynamic environments.

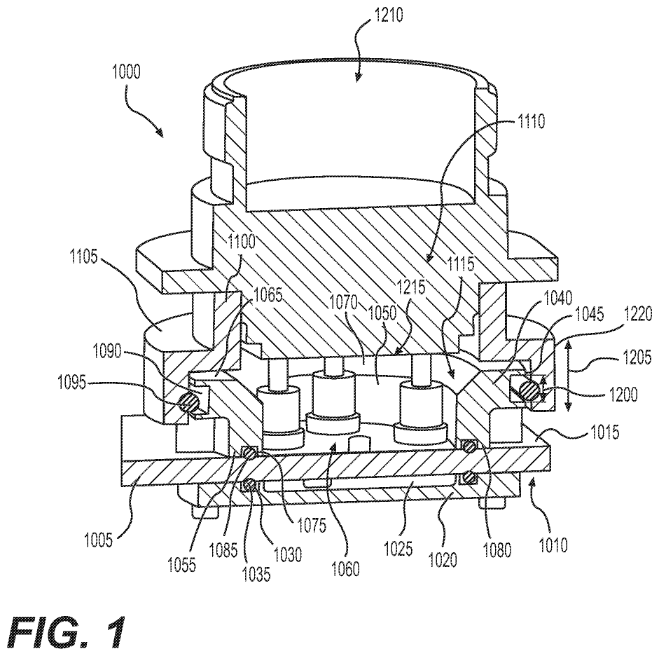

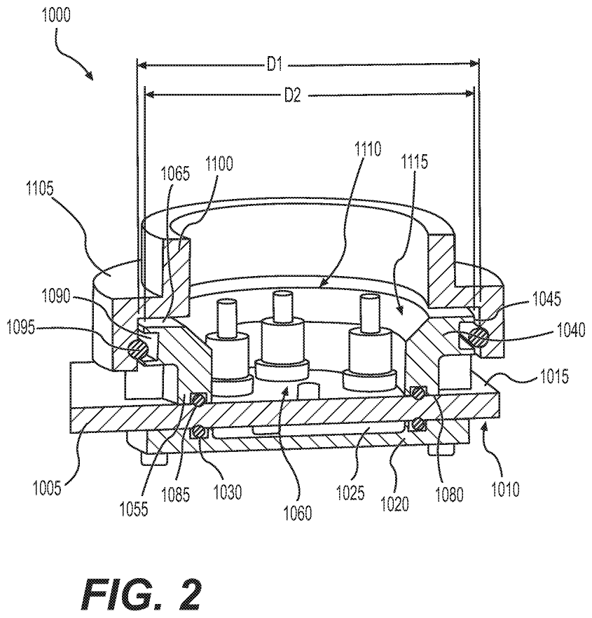

FIG. 1 illustrates a device assembly according to a certain embodiment of the present disclosure. As FIG. 1 illustrates, a backshell assembly 1000 can include a substrate 1005. The substrate 1005 has a lower surface 1010 and an upper surface 1015. The substrate 1005 can have any geometrical shape, e.g., rectangular shape, circular shape, or any other shape. The substrate 1005 can be made of any suitable material, e.g., a metal. Further, the backshell assembly 1000 can include a lower connector 1020 having a first open circular cavity 1025 defined therein. The backshell assembly 1000 can include a first groove 1030. The first groove 1030 can be located any place on the lower connector 1020. In some embodiments, the first groove 1030 is disposed around a circumference of the first cavity 1025. In some embodiments, the first groove 1030 is located closer to the edge of the lower connector 1020 than the center of the lower connector 1020.

The backshell assembly 1000 can include a first gasket 1035 disposed in the first groove 1030. The lower connector 1020 can be positioned on the lower surface 1010 of the substrate 1005 to capture the first gasket 1035 in the first groove 1030 between the lower connector 1020 and the lower surface 1010 of the substrate 1005.

Further, the backshell assembly 1000 can have a first connector 1040 with an outer surface 1045 and a space 1050 defined therein. The first connector 1040 has a first end 1060 and a second end 1070 and a virtual Z-axis is defined from the first end 1060 to the second end 1070. In some embodiments, the first connector 1040 has a cylindrical shape with a cylindrical outer surface 1045 and a cylindrical bore 1050 defined therethrough and with a first surface 1055 at a first opening 1060 of the bore 1050 and a second surface 1065 at a second end 1070 of the bore 1050.

The backshell assembly 1000 can have a second groove 1075. The second groove 1075 can be positioned in the first connector 1040 around a circumference 1080 of the first end 1060. Further, the backshell assembly 1000 can have a second gasket 1085 disposed in the second groove 1075. In some embodiments, the first connector 1040 is positioned on the upper surface 1015 of the substrate 1005 to capture the second gasket 1085 in the second groove 1075 between the first connector 1040 and the upper surface 1015 of the substrate 1005.

As FIG. 1 illustrates, the backshell assembly 1000 can have a third groove 1090 having a first length 1200 along the Z-axis and defined in the outer surface 1045 of the first connector 1040. The third groove 1090 can be adjacent to the second end 1070 of the first connector 1040. Further, the backshell assembly 1000 can include a third gasket 1095 disposed in the third groove 1090.

The backshell assembly 1000 can include a second connector 1100 having a first portion 1220 with a second length 1205 along the Z-axis. The first portion 1220 can be disposed about the second end 1070 of the first connector 1040 to enclose the third gasket 1095 in the third groove 1090 between the first connector 1040 and the second connector 1100. In some embodiments, the second connector 1100 can be a cylindrical connector with a cylindrical outer surface 1105 and a cylindrical bore 1110 defined therethrough. The second connector 1100 can have a first opening 1115 with an interior diameter D1 greater than an exterior diameter D2 of the second end 1070 of the first connector 1040.

In some embodiments, the second length 1205 of the first portion 1220 is at least as long as a first length 1200 such that the second connector 1100 is capable of moving along the Z-axis while maintaining the third gasket 1095 in the third groove 1090 between the first connector 1040 and the second connector 1100. In some embodiments, the second length 1205 is longer than the first length 1200 such that the second connector 1100 is capable of moving along the Z-axis while maintaining the third gasket 1095 in the third groove 1090 between the first connector 1040 and the second connector 1100.

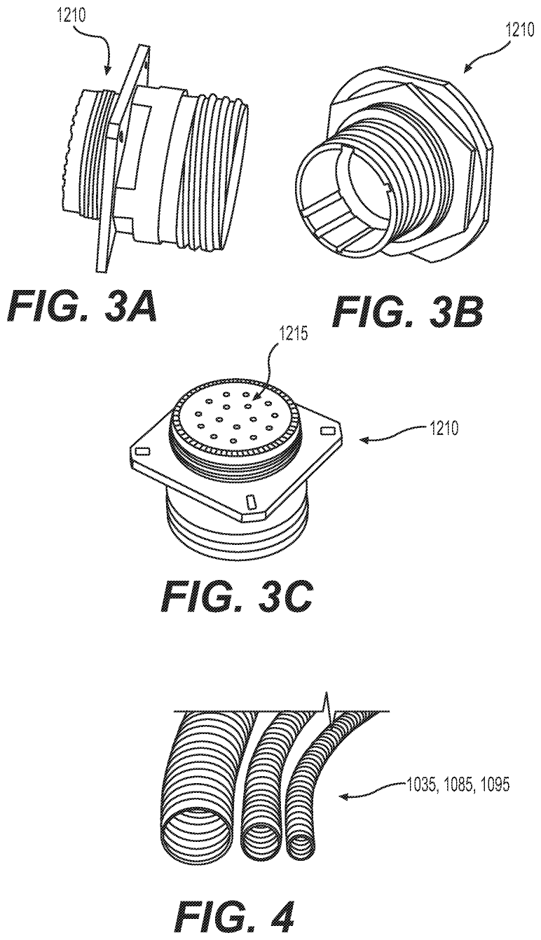

FIG. 1 shows an accessory connector 1210. The accessory connector 1210 can be a commercially available connector, e.g., an Amphenol D38999. FIGS. 3A-3C illustrate various views of the accessory connector 1210. The accessory connector 1210 connects to the backshell assembly 1000 through a connection surface 1215.

In some embodiments, the first, second, and third gaskets 1035, 1085, 1095 are EMI shielding material. In some embodiments, the first, second, and third gaskets 1035, 1085, 1095 are Spira-Shield® gaskets from company SPIRA, as shown in FIG. 4. The first, second, and the third gaskets 1035, 1085, 1095 can be any gasket that can shield against electromagnetic interference. In some embodiments, the first, second and third gaskets 1035, 1085, 1095 have circular cross-sections, allowing for movement as a radial seal in the Z-direction between the first connector 1040 and the second connector 1100.

It is appreciated that certain features of the present disclosure, which are, for clarity, described in the context of separate embodiments, may also be provided in combination in a single embodiment. Conversely, various features, which are, for brevity, described in the context of a single embodiment, may also be provided separately or in any suitable sub-combination.

Whereas many alterations and modifications of the disclosure will no doubt become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

Although the present disclosure has been described herein with reference to particular embodiments, the present disclosure is not intended to be limited to the particulars disclosed herein; rather, the present disclosure extends to all functionally equivalent structures, methods and uses, such as are within the scope of the claims.

What is claimed is:

1. A backshell assembly, comprising:
a substrate having a lower surface and an upper surface;
a lower connector;
a first gasket disposed about the lower connector;
wherein the lower connector is positioned on the substrate lower surface to capture the first gasket between the lower connector and the substrate lower surface;
a first connector with an outer surface and a space defined therein, having a first end and a second end, wherein a virtual Z-axis is defined from the first end to the second end;
a second gasket disposed around a circumference of the first connector;
wherein the first connector is positioned on the substrate upper surface to capture the second gasket between the first connector and the substrate upper surface;
a third gasket disposed about the outer surface of the first connector and adjacent to the second end of the first connector; and
a second connector having a first portion with a second length along the Z-axis,
wherein the first portion of the second connector is disposed about the second end of the first connector to enclose the third gasket between the first connector and the second connector, and
wherein the second connector is configured to maintain the third gasket between the first connector and the second connector.

2. The backshell assembly of claim 1, wherein the second length is at least as long as a diameter of the third gasket such that the second connector is capable of moving along the Z-axis to maintain the third gasket between the first connector and the second connector.

3. The backshell assembly of claim 1, wherein each of the first, second and third gaskets comprises an EMI shielding material.

4. The backshell assembly of claim 1, wherein the substrate, the lower connector, and the first connector are attached together.

5. The backshell assembly of claim 1, further comprising:
a first groove defined in the lower connector,
wherein the first gasket is disposed in the first groove.

6. The backshell assembly of claim 5, further comprising:
a second groove defined in the first connector,
wherein the second gasket is disposed in the second groove.

7. The backshell assembly of claim 6, further comprising:
a third groove defined in the outer surface of the first connector,
wherein the third gasket is disposed in the third groove.

8. The backshell assembly of claim 1, further comprising:
a power connector in contact with the second connector,
wherein the power connector is configured to provide electric power to the backshell assembly.

9. The backshell assembly of claim 8, further comprising:
a plurality of power supplies located in the space of the first connector and in contact with the substrate.

10. The backshell assembly of claim 9, wherein the power connector and the second connector are threaded together.

11. A backshell assembly, comprising:
a substrate having a lower surface and an upper surface;
a lower connector having a first groove defined therein;
a first gasket disposed in the first groove of the lower connector;
wherein the lower connector is positioned on the substrate lower surface to capture the first gasket in the first groove between the lower connector and the substrate lower surface;
a first connector with an outer surface and a space defined therein, having a first end and a second end, wherein a virtual Z-axis is defined from the first end to the second end;
a second groove defined in the first connector around a circumference of the first connector first end;
a second gasket disposed in the second groove of the first connector;
wherein the first connector is positioned on the substrate upper surface to capture the second gasket in the second groove between the first connector and the substrate upper surface;
a third groove, having a first length along the Z-axis, defined in the outer surface of the first connector and adjacent to the second end of the first connector;
a third gasket disposed in the third groove; and
a second connector having a first portion with a second length along the Z-axis,
wherein the first portion of the second connector is disposed about the second end of the first connector to enclose the third gasket in the third groove between the first connector and the second connector,
wherein the second length is at least as long as the first length such that the second connector is capable of moving along the Z-axis to maintain the third gasket in the third groove between the first connector and the second connector, and
wherein each of the first, second and third gaskets comprises an EMI shielding material.

12. The backshell assembly of claim 11, wherein the substrate, the lower connector, and the first connector are attached together.

13. The backshell assembly of claim 11, further comprising a power connector in contact with the second connector, the power connector configured to provide electric power to the backshell assembly.

14. The backshell assembly of claim 13, further comprising a plurality of power supplies located in the space of the first connector and in contact with the substrate.

15. The backshell assembly of claim 14, wherein the power connector and the second connector are threaded together.
